(19) United States
(12) Patent Application Publication
(10) Pub. No.: US 2023/0152152 A1
(43) Pub. Date: May 18, 2023

(54) AUTOMATIC FIBER END POINT DETECTION USING COHERENT OPTICAL TIME DOMAIN REFLECTOMETRY

(71) Applicant: NEC Laboratories America, Inc., Princeton, NJ (US)

(72) Inventors: Philip JI, Cranbury, NJ (US); Junqiang HU, Davis, CA (US); Ting WANG, West Windsor, NJ (US); Ming-Fang HUANG, Princeton, NJ (US); Yuheng CHEN, South Brunswick, NJ (US)

(73) Assignee: NEC LABORATORIES AMERICA, INC, Princeton, NJ (US)

(21) Appl. No.: 17/989,589

(22) Filed: Nov. 17, 2022

Related U.S. Application Data
(60) Provisional application No. 63/280,712, filed on Nov. 18, 2021.
(60) Provisional application No. 63/312,520, filed on Feb. 22, 2022.

(51) Int. Cl. G01H 9/00; H04B 10/071; G01D 5/353

(52) U.S. Cl. CPC G01H 9/006; H04B 10/071; G01D 5/35361

(57) ABSTRACT

Disclosed are distributed fiber optic sensing arrangements that—in sharp contrast to the prior art—utilize C-OTDR capabilities to detect an optical fiber end point while still maintaining operational DFOS vibration/acoustic signal sensing functions. Advantageously, such operations are performed automatically without requiring a manual confirmation. A change is made in digital signal processing in the C-OTDR operation by bypassing a high-pass-filtering stage when calculating intensity changes such that the DC signal component is preserved and used to differentiate from a “no-fiber” section. It then calculates the no-fiber section's signal level and uses a back-tracking operation to determine the fiber end automatically.

### CROSS REFERENCE

This application claims the benefit of U.S. Provisional Patent Application Ser. No. 63/280,712 filed 18 Nov. 2021 and U.S. Provisional Patent Application Ser. No. 63/312,520 filed 22 Feb. 2022 the entire contents of each being incorporated by reference as if set forth at length herein.

### TECHNICAL FIELD

This disclosure relates generally to distributed fiber optic sensing (DFOS) systems, methods, and structures. More particularly, it discloses systems and methods providing automatic fiber end point detection using coherent time domain reflectometry.

### BACKGROUND

Distributed fiber optic sensing and its variants including distributed vibration sensing have found widespread applicability in a number of contemporary applications including infrastructure monitoring, security—intrusion detection, traffic monitoring, strain and temperature measurement—among others.

One type of DFOS employs Rayleigh backscattering to monitor vibration, since Rayleigh backscattering is quite sensitive to micro fiber elongation and the micro refractive index changes caused by vibrations. The vibration signals that can be detected range from low frequency mechanical movement to high frequency acoustic or ultrasound signal. Such DFOS sensors are known in the art as distributed vibration sensor (DVS) or distributed acoustic sensor (DAS) based on its functionality.

Notably, such DFOS sensors are also known in the art as called coherent OTDR (C-OTDR) or phase OTDR (ϕ-OTDR) sensors—based on its operation principle namely optical time domain reflectometer (OTDR). Unlike conventional OTDR where the optical signal is incoherent, this type of DFOS uses coherent optical signal and monitors the phase change caused by vibration signal. Note that as used herein, the terms C-OTDR, ϕ-OTDR, DVS, and DAS are used interchangeably, even though each term has different emphasis, either on the principle or the function.

Notwithstanding its utility, and high sensitivity for detecting vibrations along the length of an optical sensing fiber, C-OTDR is not effective in measuring fiber cut location or fiber end point.

### SUMMARY

An advance in the art is made according to aspects of the present disclosure directed to distributed fiber optic sensing arrangements that—in sharp contrast to the prior art—utilize C-OTDR capabilities to detect an optical fiber end point while still maintaining operational DFOS vibration/acoustic signal sensing functions. Advantageously, such operations are performed automatically without requiring a manual confirmation.

According to a first aspect of the present disclosure, our inventive procedure changes digital signal processing in the C-OTDR operation by bypassing a high-pass-filtering stage when calculating intensity changes such that the DC signal component is preserved and used to differentiate from a “no-fiber” section. It then calculates the no-fiber section's signal level and uses a back-tracking operation to determine the fiber end automatically.

According to another aspect of the present disclosure, our inventive approach uses the new DSP scheme to generate a power profile along the sensing range, determines the power level of “no fiber” region, and uses it to determine the threshold level, and automatically finds the fiber end point by scanning through the power profile and comparing against the threshold level.

### BRIEF DESCRIPTION OF THE DRAWING

A more complete understanding of the present disclosure may be realized by reference to the accompanying drawing in which:

FIG. 1 is a schematic diagram showing an illustrative DFOS system according to aspects of the present disclosure;

FIG. 2 is a plot showing an illustrative C-OTDR vibration signal calculated from relative phase change according to aspects of the present disclosure;

FIG. 3 is a plot showing an illustrative C-OTDR vibration signal calculated from intensity change according to aspects of the present disclosure;

FIG. 4 is a plot showing an illustrative OTDR output according to aspects of the present disclosure;

FIG. 5 is a flow diagram showing an illustrative method according to aspects of the present disclosure;

FIG. 6 is a plot showing an illustrative calculated C-OTDR power profile according to aspects of the present disclosure;

FIG. 7 is a plot showing an illustrative C-OTDR power profile with vibration at some locations according to aspects of the present disclosure;

FIG. 8 is a schematic diagram showing an illustrative approach to inner fiber identification by DFOS (DAS/DVS) according to aspects of the present disclosure;

FIG. 9 is a schematic diagram showing an illustrative interaction between central office and field locations according to aspects of the present disclosure;

FIG. 10 is a plot showing an illustrative power profile near a fiber cut location according to aspects of the present disclosure;

FIG. 11 is a plot showing an illustrative power profile of the fiber shown in FIG. 10 after a good termination according to aspects of the present disclosure;

FIG. 12 is a plot showing an illustrative power profile of the fiber shown in FIG. 10 after a not-so-good termination according to aspects of the present disclosure;

FIG. 13 is a schematic diagram showing illustrative overall operation application of our systems and methods according to aspects of the present disclosure; and

FIG. 14 is a schematic diagram showing illustrative operational features according to aspects of the present disclosure.

### DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGS. comprising the drawing are not drawn to scale.

By way of some additional background, we begin by noting that distributed fiber optic sensing (DFOS) is an important and widely used technology to detect environmental conditions (such as temperature, vibration, acoustic excitation vibration, stretch level etc.) anywhere along an optical fiber cable that in turn is connected to an interrogator. As is known, contemporary interrogators are systems that generate an input signal to the fiber and detects/analyzes the reflected/scattered and subsequently received signal(s). The signals are analyzed, and an output is generated which is indicative of the environmental conditions encountered along the length of the fiber. The signal(s) so received may result from reflections in the fiber, such as Raman backscattering, Rayleigh backscattering, and Brillion backscattering. DFOS can also employ a signal of forward direction that uses speed differences of multiple modes. Without losing generality, the following description assumes reflected signal though the same approaches can be applied to forwarded signal as well.

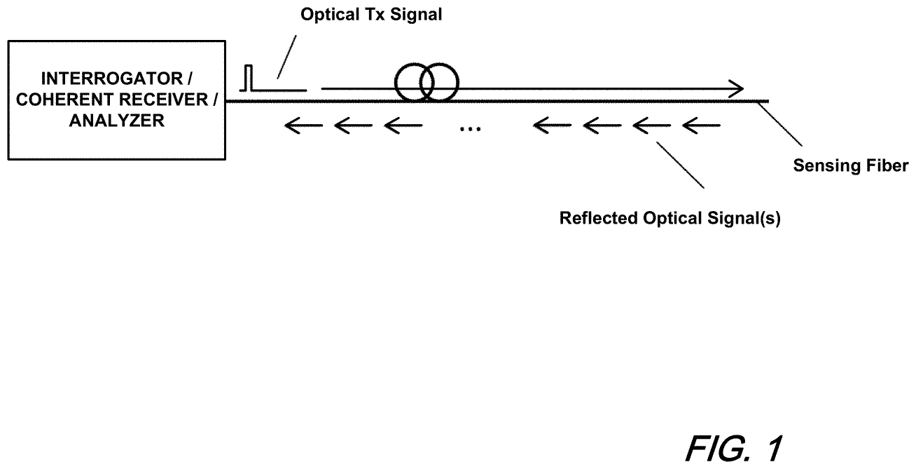

FIG. 1 is a schematic diagram of a generalized, DFOS system. As will be appreciated, a contemporary DFOS system includes an interrogator that periodically generates optical pulses (or any coded signal) and injects them into an optical fiber. The injected optical pulse signal is conveyed along the optical fiber.

At locations along the length of the fiber, a small portion of signal is reflected and conveyed back to the interrogator. The reflected signal carries information the interrogator uses to detect, such as a power level change that indicates—for example −a mechanical vibration. While not shown in detail, the interrogator may include a coded DFOS system that may employ a coherent receiver arrangement.

The reflected signal is converted to electrical domain and processed inside the interrogator. Based on the pulse injection time and the time signal is detected, the interrogator determines at which location along the fiber the signal is coming from, thus able to sense the activity of each location along the fiber.

Those skilled in the art will understand and appreciate that by implementing a signal coding on the interrogation signal enables the sending of more optical power into the fiber which can advantageously improve signal-to-noise ratio (SNR) of Rayleigh-scattering based system (e.g. distributed acoustic sensing (DAS) or distributed vibration sensing (DVS)) and Brillouin-scattering based system (e.g. Brillouin optical time domain reflectometry or BOTDR).

As currently implemented in many contemporary implementations, dedicated fibers are assigned to DFOS systems in fiber-optic cables—physically separated from existing optical communication signals which are conveyed in different fiber(s). However, given the explosively growing bandwidth demands, it is becoming much more difficult to economically operate and maintain optical fibers for DFOS operations only. Consequently, there exists an increasing interest in integrating communications systems and sensing systems on a common fiber that may be part of a larger, multi-fiber cable or a common fiber that simultaneously carries live telecommunications traffic in addition to the DFOS data.

Operationally, we assume that the DFOS system will be Rayleigh-scattering based system (e.g., distributed acoustic sensing or distributed vibration sensing) and Brillouin-scattering based system (e.g., Brillouin optical time domain reflectometry or BOTDR) and may include a coding implementation. With such coding designs, such systems will be most likely be integrated with fiber communication systems due to their lower power operation and will also be more affected by the optical amplifier response time.

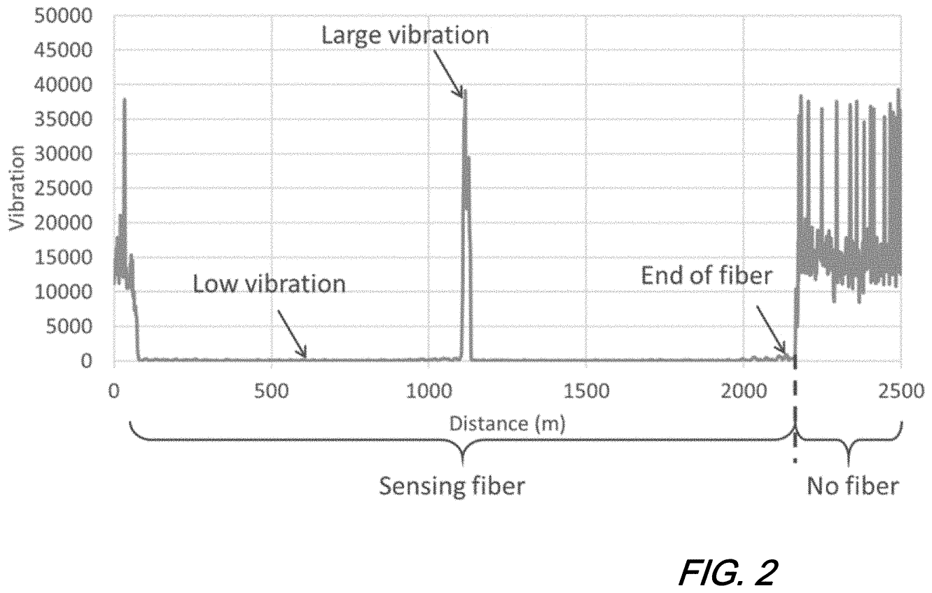

As noted previously, even though C-OTDR can provide high sensitivity detection of vibration or acoustic signal, it is not effective in measuring fiber cut location or fiber end point. For example, some C-OTDR uses relative phase change within each gauge length on the optical fiber to calculate the vibration. In the calculated vibration results, a low value means that there is low vibration signal, but a large value can mean either a large vibration signal or no fiber, because both can generate large phase change, as shown in FIG. 2 which is a plot showing an illustrative C-OTDR vibration signal calculated from relative phase change according to aspects of the present disclosure.

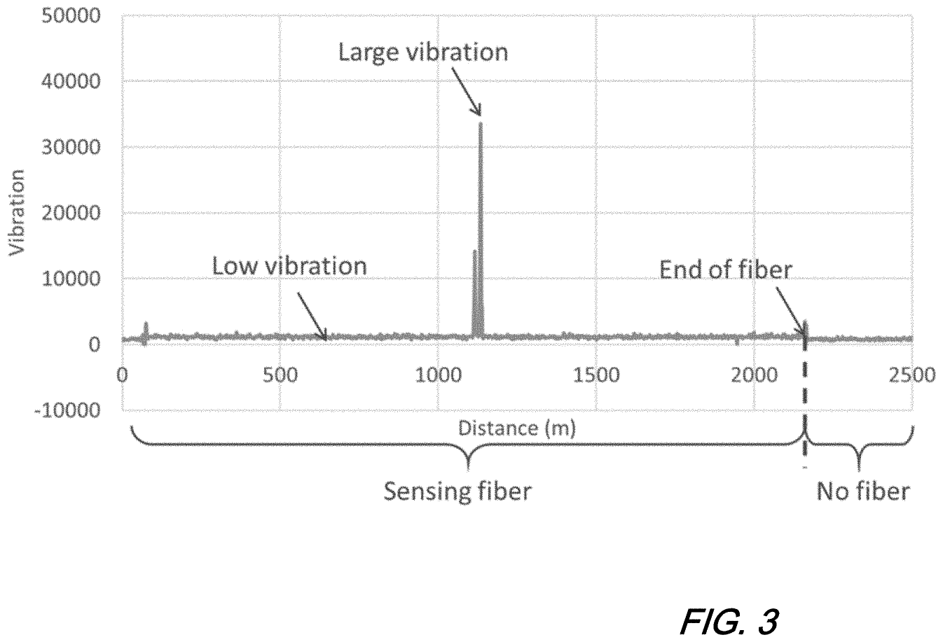

Some C-OTDR uses the optical signal intensity change caused by the interference of signals within each gauge length on the optical fiber to calculate the vibration. In the calculated vibration results, a large value means a large vibration signal, but a low value can mean either low vibration or no fiber, as shown in FIG. 3 which is a plot showing an illustrative C-OTDR vibration signal calculated from intensity change according to aspects of the present disclosure.

Therefore, it is not possible to use the calculated vibration values to determine whether there is fiber or not using these C-OTDR signal analysis methods, and thus it is not possible to determine the fiber end point or fiber cut location easily using C-OTDR data.

On the other hand, there is a strong demand to determine the fiber end point or fiber cut location in most of the DFOS applications, such as finding if the fiber for the perimeter intrusion detection system is cut by the intruder, or if the fiber buried along the highway for traffic monitoring is damaged/cut by unauthorized construction and excavation. Therefore, it is important to find a solution to calculate the fiber end point automatically easily on the C-OTDR.

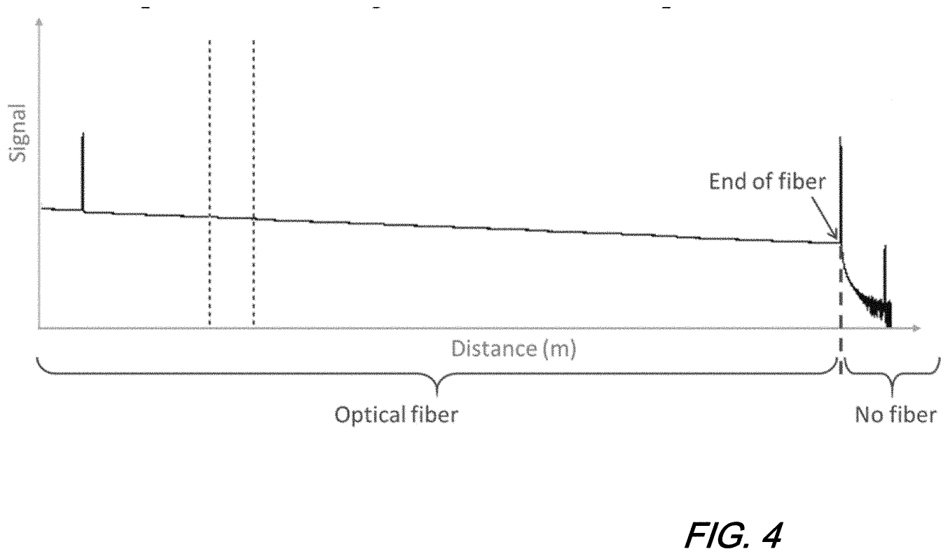

One way to do it is to combine it with a traditional OTDR, which has the capability of showing the fiber end point location. FIG. 4 shows an example of traditional OTDR output as a plot showing an illustrative OTDR output according to aspects of the present disclosure.

As shown in the example, the fiber end point can be easily observed on the traditional OTDR. The main reason why traditional OTDR can provide an indication of the fiber end point on the plot while the C-OTDR cannot is the light source. Traditional OTDR uses incoherent light source, which is usually a broader band light source with a wide range of wavelength/frequency components. The received Rayleigh backscattering signal from these components are averaged out to provide a steady optical intensity level.

On the other hand, the C-OTDR uses narrow linewidth light source for coherent operation, therefore the output is sensitive to external vibration experience by the fiber, which is the desirable ability of the C-OTDR, but it also means that it cannot provide a steady intensity level and thus cannot indicate the fiber end point. (On the contrary, the traditional OTDR is not sensitive to vibration, and therefore cannot be used for vibration/acoustic signal sensing). Therefore, a way to provide both vibration sensing and fiber end detection is to have two systems (C-OTDR and traditional OTDR) in the instrument. But this is costly and bulky. Also, these two systems cannot operate at the same time, making the operation inconvenient/impractical.

A solution to this is to set up two types of light sources in the system (broader band light source for traditional OTDR function, and narrow linewidth light source for C-OTDR function) and share the rest of the optoelectronic components. This is more economical than having two parallel systems, however it still requires two light sources (usually lasers), and electronic circuitry to switch between them to perform different functions.

There are other techniques to improve that, such as sweeping the laser wavelength and collect the data multiple times under different wavelengths to calculate the averaged signal or use an optoelectronic scrambler to scramble the signal multiple times and then collect the data to calculate the averaged signal. These schemes require multiple measurements each time, therefore is not time efficient. They also require additional hardware components (such as tunable laser and scrambler, with respective control circuitry), which adds to the system cost, size, and control complexity.

Furthermore, these methods still rely on human visual analysis to determine the fiber end point and cannot provide an automatic end point detection scheme.

We now show and describe a scheme that uses only the C-OTDR hardware to perform fiber end point detection while still maintaining the same vibration/acoustic signal sensing function. Advantageously, our inventive approach automatically determines a fiber end point location without manual inspection and therefore does not require additional cost.

Our inventive scheme changes digital signal processing in the C-OTDR by bypassing a high-pass-filtering stage when calculating the intensity change, so that the DC signal component will remain, which is used to differentiate from the no-fiber section. It then calculates the no-fiber section's signal level and uses a back-tracking operation to determine the fiber end automatically.

As will be appreciated by those skilled in the art, our inventive approach uses a new DSP scheme to generate the power profile along the sensing range, determines the power level of “no fiber” region, and use it to determine the threshold level, and automatically finds the fiber end point by scanning through the power profile and comparing against the threshold level.

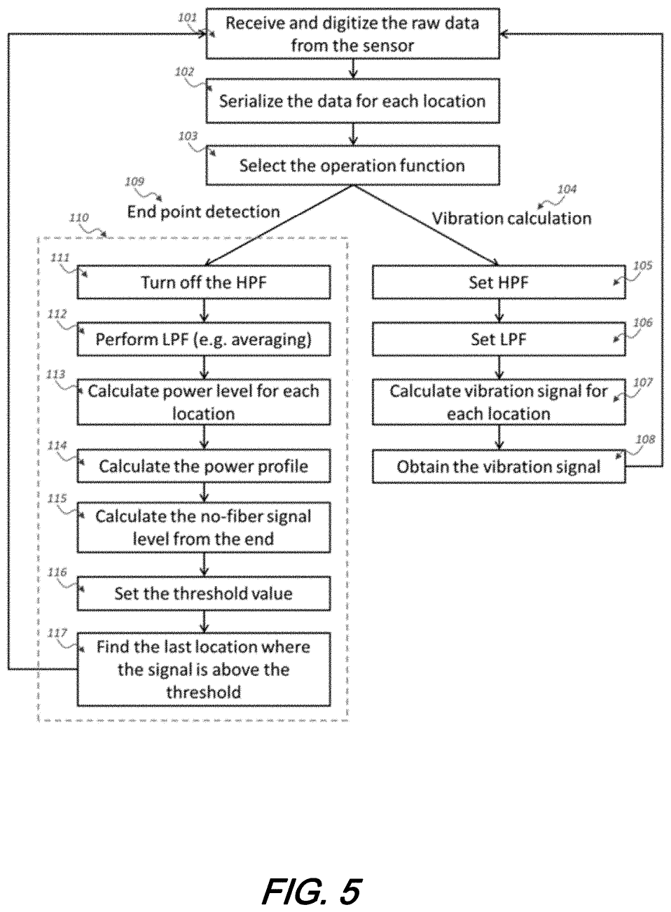

FIG. 5 is a flow diagram showing an illustrative method according to aspects of the present disclosure. The method finds fiber end location and the flow chart shows the overall operation of the entire fiber optic sensor system, including the regular vibration detection operation.

With reference to that figure, we note that during the operation of a C-OTDR sensor, optical pulses from the laser source are transmitted within sensing fiber periodically. The Rayleigh backscattering signal generated from each pulse at each location on the fiber is received by the optical receiver when it returns to the sensor (the interrogator). These signals are digitized and subsequently processed via DSP (digital signal processing). These are the raw data from the sensor [101]. For each location on the fiber, the raw data of the received Rayleigh backscattering signals from the periodic pulses are then serialized individually into separate time series [102]. The subsequent steps of processing are performed on each time series of data, each one of them corresponds to one location on the sensing fiber, as shown in the figure.

In conventional C-OTDR, the subsequent steps are to perform vibration calculation to obtain the vibration information on the fiber, which includes the steps such as setting a high pass filter (HPF) to remove the baseband noise near the DC [105], then setting a low past filter (LPF) to remove the high frequency noise and aliasing [106], then use the filtered data to calculate the vibration signal for each location [107], and then combine the vibration signals from all locations to produce the vibration information for the entire sensing fiber [108]. In some alternative implementations, the HPF and LPF are replaced with an equivalent bandpass filter (BPF) to remove the DC offset and the high frequency noise.

For the new function to detect the fiber end, the serialized data are processed differently. Firstly, the DSP (which could be the FPGA firmware or software on a computer) determines which function to take [103], based on the required function at that time. If the vibration calculation function is selected [104], the data will go through the same processing as above [105-108], but if the end point detection function is selected [109], different processing steps will be taken, as shown in the dashed box [110].

In the end point detection operation, the first step is to turn off (or bypass) the HPF function of the vibration calculation processing [111]. An example of the HPF function is to use an IIR digital filter to obtain the DC signal, which is then subtracted from the input signal. Even though the baseband (low frequency) noise from the optoelectronic hardware will remain, it is acceptable for the function of end point detection. The subsequent LPF steps, such as performing averaging, is not changed [112]. In the BPF case, the bandpass filter will be reconfigured to keep the DC offset at this step.

From the filtered signal, the optical power of each location can be calculated [113]. The calculation process is similar to the vibration calculation step 107 however the result does not only contain the vibration signal, but also the low frequency noise. The calculated optical power from all locations are combined to produce the power profile for the entire sensing fiber [114].

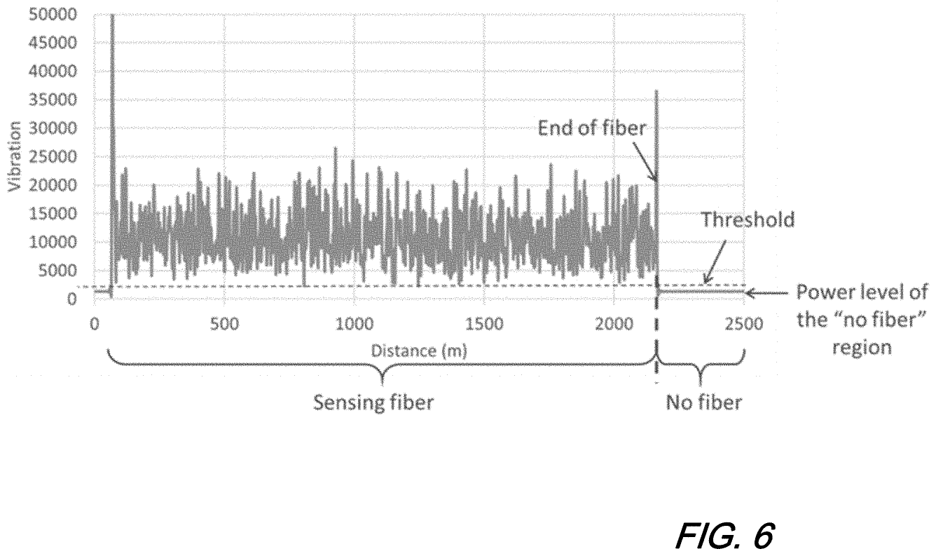

FIG. 6 is a plot showing an illustrative calculated C-OTDR power profile according to aspects of the present disclosure.

From this figure it can be observed that the characteristic of this result is different from the results obtained from the relative phase change-based vibration (FIG. 2) or intensity change-based vibration (FIG. 3). Here, the sections with fiber and the section outside the fiber can be clearly distinguished. Also, it can be noticed that like the results from the traditional OTDR (FIG. 4), there is a peak at the end of fiber, which is caused by the large reflection at the fiber end point (this can be eliminated by proper termination at the fiber end point). However, unlike FIG. 4, there is no steady power level in the fiber section. Therefore, this result cannot be used to obtain the fiber attenuation information like in the traditional OTDR, but it is sufficient for the end point detection purpose.

The subsequent steps automatically identify the location of the fiber end point without manual observation. Here, we assume/require that the measurement distance of the C-OTDR is longer than the actual fiber length (otherwise there is no fiber end within the sensor's reach, and thus it won't be meaningful to detect the fiber end from the sensing results). Also, we can assume/require that the section outside the fiber is substantial (such as tens of meters or more). This is a reasonable assumption/requirement, because it is usually the case in actual operation, or can be easily achieved by setting the sensing range of the C-OTDR substantially longer. Therefore, we can be sure that the end of the measurement profile is without fiber, as shown in the example in FIG. 6.

We can then calculate the power profile level at this region automatically by the DSP processor [115]. To avoid any potential error caused by noise, it is recommended to take the average of the signal across a substantial length within this region, if it doesn't reach the section with actual sensing fiber.

A threshold level value is set by adding 10% to 20% to the averaged signal level [116]. This is to prevent ambiguity in the automatic end point determination. A simple scan is performed on the power profile data from the near end (lower distance, closest to the C-OTDR interrogator) to the end of the sensing range to determine the last (i.e., the furthest) location where the signal is above the threshold [117]. The location is the detected fiber end point. The end point detection operation is then completed, and the system can continue to perform the next task, such as vibration sensing.

It should be noted that this scheme does not require the peak at the end point of the fiber to find the end point location. Therefore, even if the peak is removed by properly terminating the fiber (such as making large bending, using index matching liquid, or using angled connector), the end point can still be detected easily using the proposed scheme.

It should also be noted that vibration along the fiber will not affect the characteristics of the power profile result obtained in this scheme.

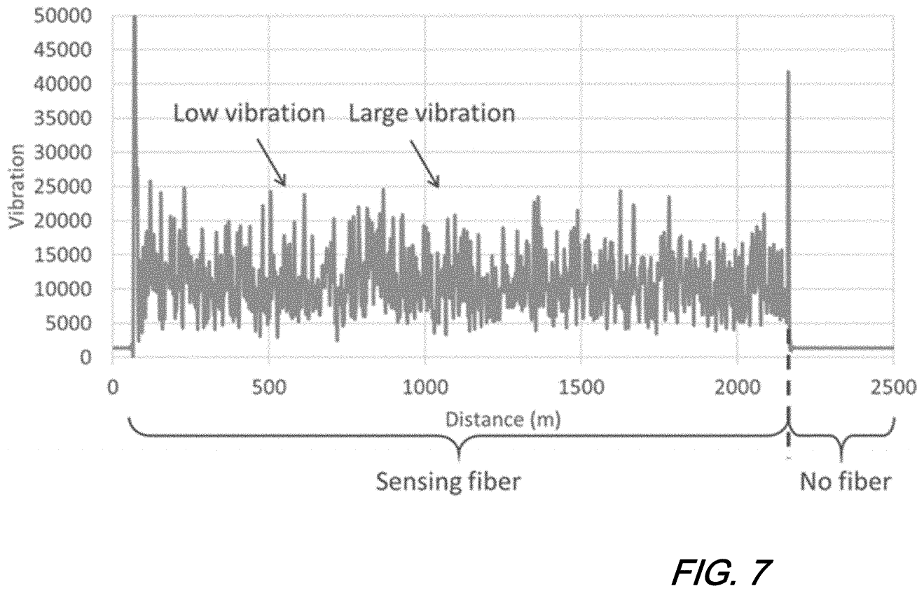

FIG. 7 is a plot showing an illustrative C-OTDR power profile with vibration at some locations according to aspects of the present disclosure. It is another example of the power profile curve. Large vibration was applied at some locations within the fiber. However, it doesn't produce a peak from the calculation, unlike in FIG. 2 and FIG. 3. This shows that this fiber end point detection scheme according to the present disclosure is quite robust and is not affected by movements along the fiber.

Accordingly, those skilled in the art will understand and appreciate that our inventive scheme is an effective solution to detect the fiber end point location automatically and quickly (within one data processing cycle, which is usually much less than 1 second). It exhibits a minimal disruption to the vibration sensing process, since it only takes up much less than 1 second of sensing time, which can usually be ignored. Since fiber end point doesn't change unless new events occur (such as a new fiber break), it only needs to be performed occasionally. Consequently, our inventive scheme will not affect the regular vibration sensing.

Compared to traditional OTDR, our inventive scheme can perform the main function of C-OTDR, which is vibration sensing. Also, it can produce the end point information automatically. Compared to modified C-OTDR, such as adding wavelength sweeping laser or scrambler, this scheme does not require any additional hardware or any hardware modification, and therefore requires no additional cost, space, or control complexity. Therefore, it is an efficient and cost-effective solution to add the fiber end point detection function to the C-OTDR.

At this point we note that telecommunications network operators will typically use a light source (such as a red light or an ASE broadband light) and an optical power meter to check each fiber in the cable to identify a particular one. However, such operation requires that any existing services to be discontinued, in addition to exhibiting serious distance limitations.

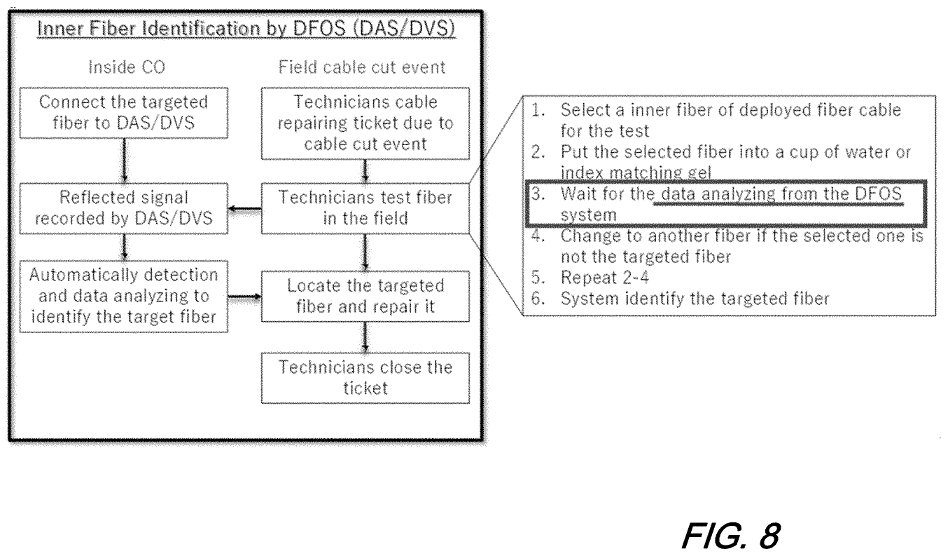

Recently, it has been proposed to use distributed fiber optic sensing (DFOS) technology to identify the individual fibers inside a fiber optic cable, which is both labor-efficient and time-efficient One important step of such operation uses a DFOS system located at the central office (CO) to analyze data to provide results to a mobile device located in the field. FIG. 8 is a schematic diagram showing an illustrative approach to inner fiber identification by DFOS (DAS/DVS) according to aspects of the present disclosure. Such operation however, does not provide for the DFOS system analysis or processing of the data to determine whether a fiber under test is a fiber of interest.

We now describe a related method (scheme, procedure) to automatically analyze field data collected from DFOS and inform a field technician of the result (whether the fiber-under-test is the correct fiber or not) instantly. With this method, the DFOS-based inner fiber identification system can be implemented.

According to our inventive method, the fiber end point is first identified automatically using the optical power profile analysis described previously. Then the fact that the fiber end surface produces a high reflection peak is utilized, and the reflection peak level is recorded by analyzing a small region near the fiber end point, which is then used to set an appropriate threshold. The optical power profile is then continuously measured and compared with the threshold in real time to generate the decision.

Operationally, our inventive method uses a power profile-based analysis method to automatically identify the fiber end point location, automatically finds the peak level of far end reflection, sets an appropriate threshold for comparison, and constantly analyze the near-end power level to check the power variation and make the decision for each fiber-under-test.

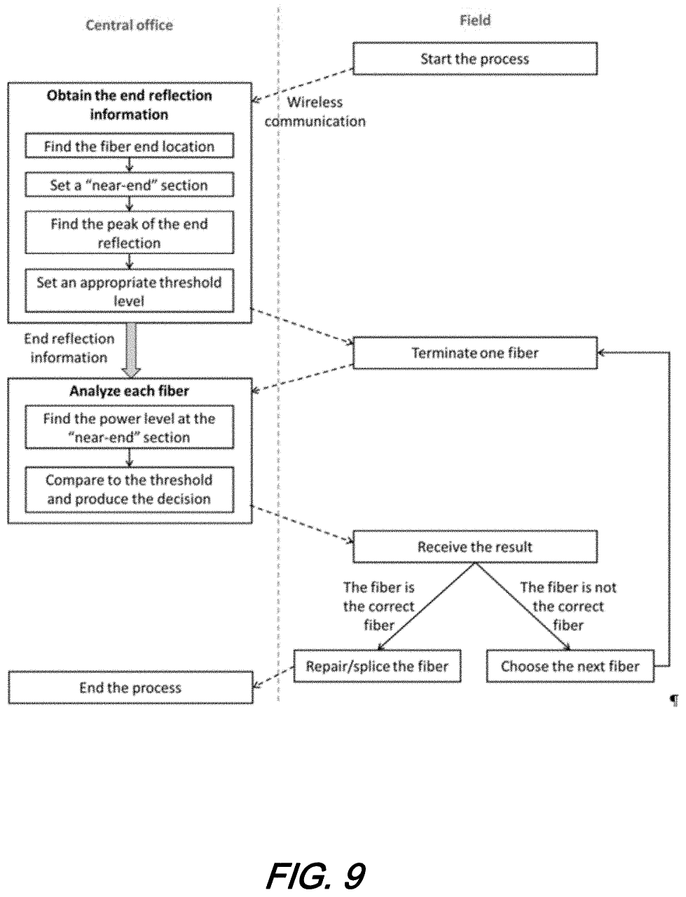

FIG. 9 is a schematic diagram showing an illustrative interaction between central office and field locations according to aspects of the present disclosure.

With reference to that figure, it may be observed that the entire operation takes place at two locations, one is the central office, where the DFOS system including interrogator and analyzer—which may include supplemental computing resources—is located. The second location is the field, where the fiber cut occurs. The sensing fiber extends from the DFOS system at the central office to the field location, however the information exchange between these 2 locations in this procedure is done through wireless communication channel (such as Wide Area Network), as illustrated in the flow chart of the figure.

Operationally, when a fiber cut event occurs and a technician reaches the fiber cut location in the field, the process starts. The processor (such as a computer or an FPGA module) at the central office performs the first task of obtaining the fiber end reflection information.

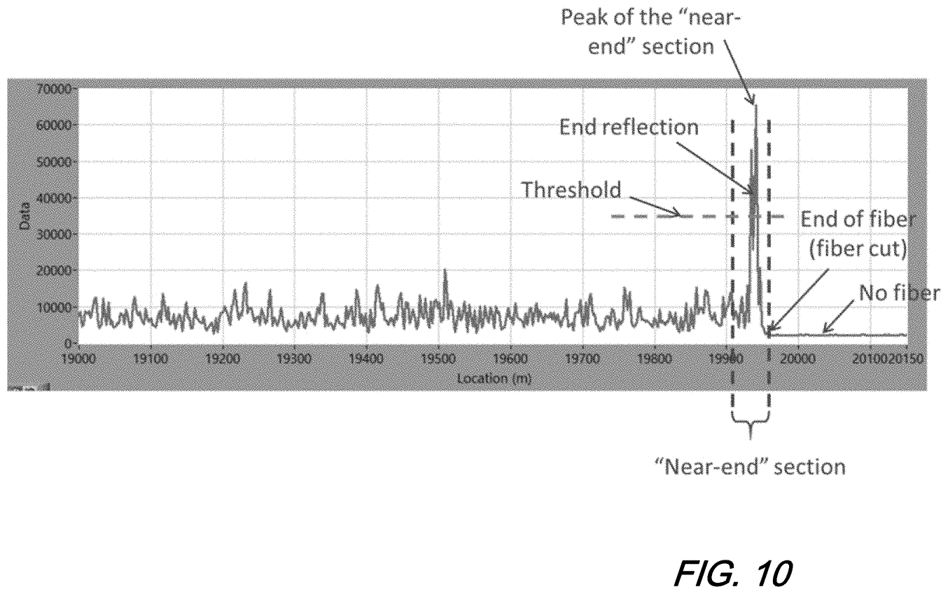

First, the DFOS sensor configuration/setting is changed to enable it to view the power profile, because the regular configuration of DAS and DVS cannot provide the power profile information (the readings are the vibration information, not the power profile). By analyzing the power profile, the fiber end point location can be identified, as shown in FIG. 10 which is a plot showing an illustrative power profile near a fiber cut location according to aspects of the present disclosure.

Next, a “near-end” section is selected, such as 5˜10 meters from the end of the fiber. When a fiber cut occurs in the field, the termination at the fiber cut point won't be a proper one (examples of a proper termination are dipping in index-matching gel, or forming loops with small bending radius, or polishing and making angled surface), and therefore there will be a large reflection near the fiber end point, and thus, a peak will appear in this “near-end” regions on the power profile, as shown in FIG. 10.

By finding the maximum value of the power profile data within the “near-end” section, the power level of the reflection peak can be identified. Note that this peak value will fluctuate over time, however it is still much higher than the power level at the other sections of the fiber, like the example in FIG. 10. Therefore, the peak value recorded at any time is acceptable.

Next, a threshold is set, which is between the peak level and the “no fiber” level. Since the power level at the “no fiber” region is almost 0, the threshold can be set at 50% or 40% of the peak level.

At this point of the operation, task 1 is then completed. Task 1 only needs to be done once, at the beginning of the entire operation. It is done automatically by a processor, without manual operation. This is a direct analytical method, and does not require any machine learning operation, therefore it is fast and computationally efficient.

After Task 1 is completed, the technician in the field is informed, and instructed to test the individual fibers one by one or by groups. The technician will terminate select one fiber (or one group of fibers), such as dipping the end into index matching gel, or forming loops with small bending radius, and hold it for a short period of time (such as one or several seconds).

At the central office, the processor starts Task 2, which constantly finds the maximum power level within the previously determined “near-end” section, checks if the maximum level falls below the pre-determined threshold level, and sends the result to the technician in the field.

If the fiber-under-test is the correct fiber (i.e. the one connected to the DFOS sensor), or if the fiber group contains the correct fiber, the large reflection near the fiber end will be suppressed or eliminated after the proper termination action.

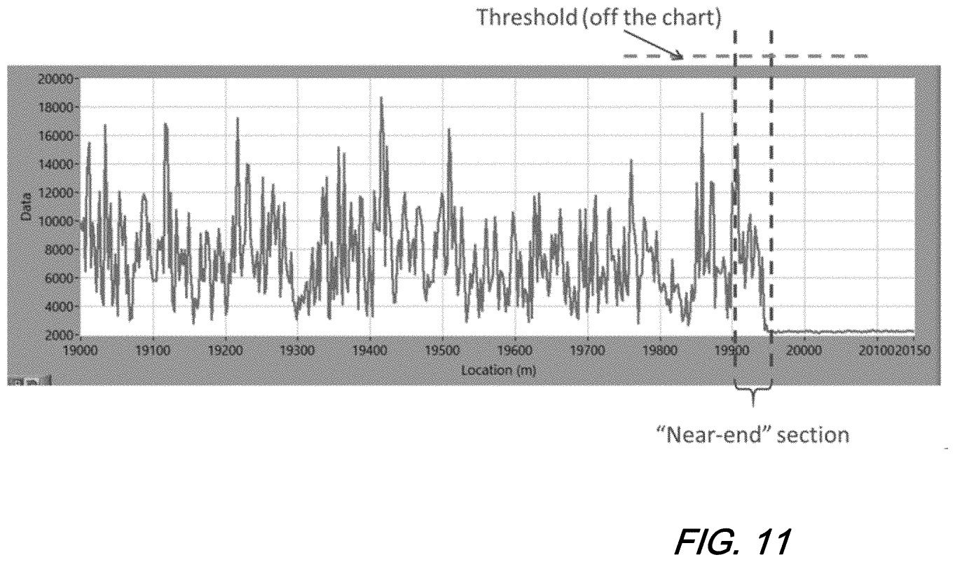

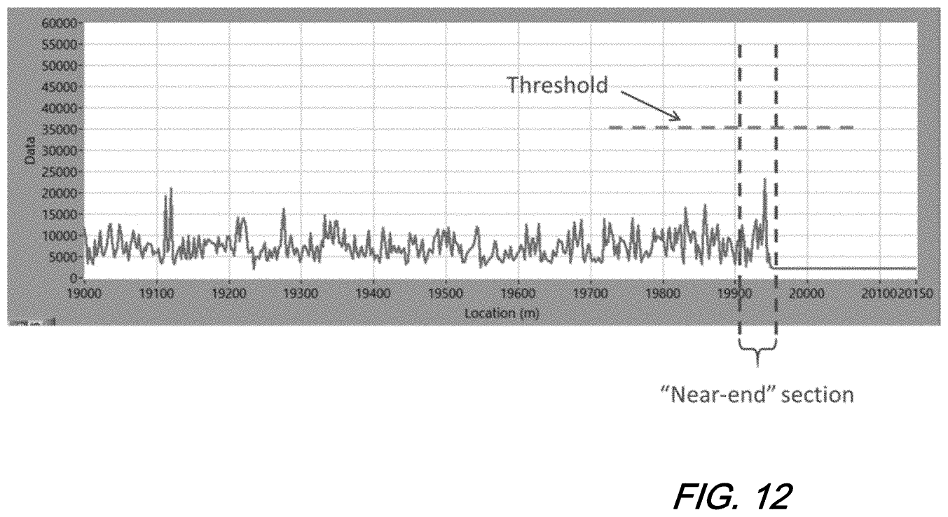

FIG. 11 is a plot showing an illustrative power profile of the fiber shown in FIG. 10 after a good termination according to aspects of the present disclosure and FIG. 12 is a plot showing an illustrative power profile of the fiber shown in FIG. 10 after a not-so-good termination according to aspects of the present disclosure.

FIG. 11 shows a good termination, in which the end reflection peak completely disappeared. FIG. 12 shows a not-so-good termination, which still contains a small residual peak at the end, but is already greatly suppressed and still well below the threshold, so it can be easily detected. (Please note that the Y-axis scales in FIGS. 11 & 12 are different from FIG. 10.) This also shows that the requirement for the termination does not need to be very strict, even a not-so-perfect termination will work.

When the correct fiber(s) is/are selected, the measured maximum power level within the “near-end” section will be below the threshold. Then the processor will inform the operator that the fiber-under-test is (or contains) the correct fiber. Otherwise, the processor will send a message that it is not (or does not contain) the correct fiber. In that case, the technician will move to another fiber (or another group of fibers) and repeat the testing process, until the correct fiber is identified.

This task is performed continuously multiple times, until the technician instructs the processor to end the process. Even when the correct fiber is identified, the technician can repeat the process multiple times to confirm it, before ending the process.

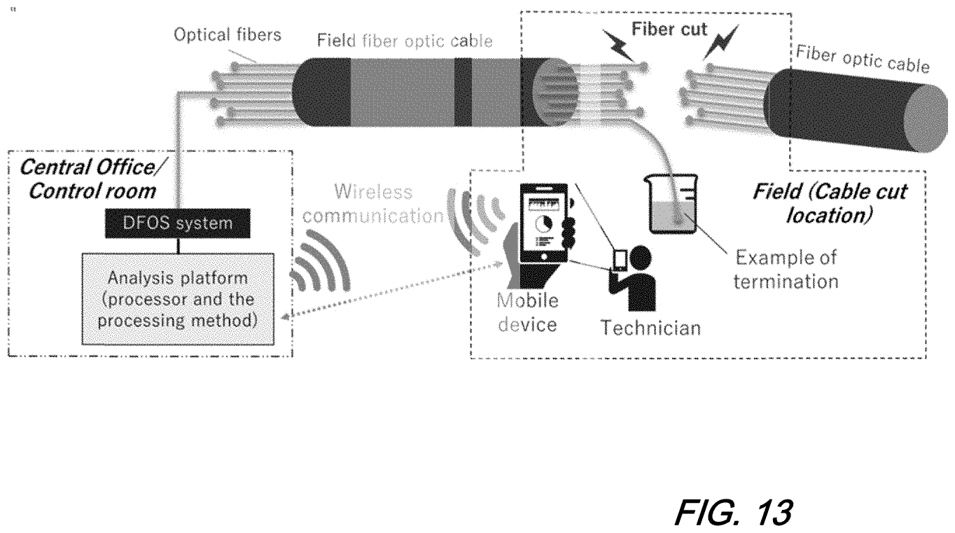

FIG. 13 is a schematic diagram showing illustrative overall operation application of our systems and methods according to aspects of the present disclosure.

Most of the procedure steps in this operation are performed at the central office by the DFOS analyzer, which includes a processor and operating software that when executed produces the processing method. The remaining procedure steps are conducted in the field by the technician, who may communicate with the central office via wireless communication. While our figure only shows one example of the termination method, a similar operation may be done on the other side of a broken fiber at the destination central office, so that the corresponding fiber can be identified. These 2 fibers can then be spliced to restore the service. The procedure can then be performed for other broken fiber pairs to restore entire services.

In summary, our inventive procedure allows a technician to easily identify each fiber affected by a fiber cut event and speeds up the repair procedure and keeps the data/service loss to minimum.

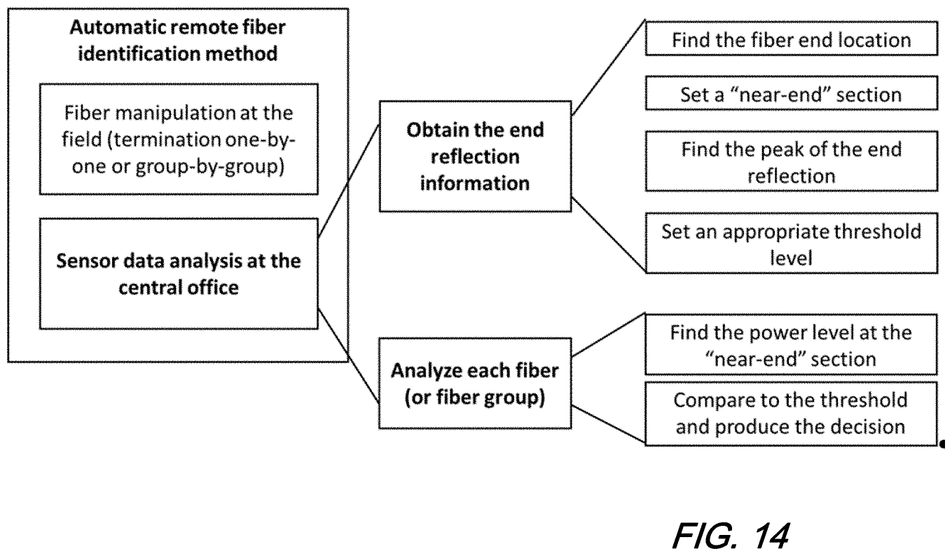

FIG. 14 is a schematic diagram showing illustrative operational features according to aspects of the present disclosure. This figure illustrates the application of this technology, which corresponds to the flow chart shown previously.

At this point, while we have presented this disclosure using some specific examples, those skilled in the art will recognize that our teachings are not so limited. Accordingly, this disclosure should only be limited by the scope of the claims attached hereto.

1. A method providing automatic fiber end point detection using optical time domain reflectometry (C-OTDR), the method comprising:
providing a distributed fiber optic sensing system (DFOS) including:
a length of optical sensor fiber;
a DFOS interrogator in optical communication with the optical sensor fiber, said DFOS interrogator configured to generate optical pulses, introduce the generated pulses into the length of optical sensor fiber, and receive backscattered signals from the length of the optical sensor fiber; and
an intelligent analyzer configured to analyze the backscattered signals received by the DFOS interrogator and further configured to provide operational functions selected from the group consisting of determining vibrational activity at points along the length of the optical sensor fiber and determine an end point of the length of optical sensor fiber; and
operating the DFOS system such that it operates to determine the vibrational activity at points along the length of the optical sensor fiber or determine the end point of the length of optical sensor fiber as selectively configured by a user of the DFOS system.

2. The method of claim 1 wherein the DFOS system is a distributed fiber optic sensing/distributed vibrational sensing (DFOS/DVS) system.

3. The method of claim 2 further comprising digitizing the backscattered signals and then serializing the digitized signals into a separate time series for each location along the length of the sensor fiber.

4. The method of claim 3 further comprising:
selectively configuring the DFOS system, by a user, to operate as a DFOS/DVS and determine vibrational activity at points along the length of the optical sensor fiber.

5. The method of claim 4 further comprising determining vibration activity at each location along the length of the optical sensor fiber from the separate time series for each location.

6. The method of claim 3 further comprising:
selectively configuring the DFOS system, by a user, to operate to determine the end point of the optical sensor fiber.

7. The method of claim 6 further comprising
determining a power level at each location along the length of the optical sensor fiber from the separate time series for each location.

8. The method of claim 7 further comprising:
determining a power profile for the entire length of the optical sensor fiber by combining the determined power level all locations.

9. The method of claim 8 further comprising:
determine a no-fiber signal level from the end of the fiber and setting a threshold value corresponding to that no-fiber signal level.

10. The method of claim 9 further comprising:
determining a location along the fiber where a signal level is above the set threshold, and identifying that determined location as an end point.
